(19) United States
(12) Patent Application Publication
(10) Pub. No.: US 2024/0134127 A1
(43) Pub. Date: Apr. 25, 2024

(54) OPTICAL SWITCH

(71) Applicant: NIPPON TELEGRAPH AND TELEPHONE CORPORATION, Tokyo (KR)

(72) Inventors: Chisato FUKAI, Musashino-shi, Tokyo (JP); Kunihiro TOGE, Musashino-shi, Tokyo (JP); Yoshiteru ABE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/273,177

(22) PCT Filed: Feb. 3, 2021
(86) PCT No.: PCT/JP2021/003954

§ 371 Date: Jul. 19, 2023

(51) Int. Cl. G02B 6/35; G02B 6/02; G02B 6/38

(52) U.S. Cl. CPC G02B 6/354; G02B 6/02042; G02B 6/381

(57) ABSTRACT

An object of the present disclosure is to provide a simple, compact optical switch with low power consumption. The present disclosure is an optical switch that includes: a first multi-core optical fiber having a plurality of cores on the same circumference from a central axis in a cross section perpendicular to a long axis direction; a first ferrule incorporating the first multi-core optical fiber; a second multi-core optical fiber in which cores are arranged at respective positions corresponding to the plurality of cores of the first multi-core optical fiber in a cross section perpendicular to the long axis direction; a second ferrule incorporating the second multi-core optical fiber and having an outer diameter equal to that of the first ferrule; a split sleeve for accommodating the first ferrule and the second ferrule in such a manner that the first ferrule and the second ferrule are opposed to each other on a central axis; a slit space adjustment jig for adjusting a space of a slit of the split sleeve; and a rotation mechanism for rotating one of the first ferrule and the second ferrule around the central axis.

### TECHNICAL FIELD

The present invention relates to an optical switch for switching an optical path using an optical fiber.

### BACKGROUND Art

Various mechanical optical switches have been proposed as all optical switches that perform path switching without converting an optical signal into an electric signal (see, for example, NPL 1). Of these mechanical optical switches, an optical fiber type mechanical optical switch for controlling the butting of optical fibers or optical connectors by a robot arm, a motor or the like has a low switching speed but has low loss and low wavelength dependence, and is thus excellent in multi-port property and self-retention function when the power source is lost.

Examples of typical structures of the optical fiber type mechanical optical switches include a system where a stage is moved in parallel using an optical fiber V-groove, a system where a mirror or a prism is selectively coupled to a plurality of optical fibers emitted from an incident optical fiber by moving the mirror or prism in parallel or changing angles, and a system where a jumper cable with an optical connector is connected by using a robot arm.

Also, as an optical path for switching, an optical switch for switching multiple paths collectively by combining a three-dimensional MEMS optical switch with a multi-core optical fiber has been proposed (see, for example, NPT 2). There has also been proposed an optical fiber type mechanical optical switch that performs switching by rotating a cylindrical ferrule into which a multi-core optical fiber is inserted (see, for example, PTL 1).

### CITATION LIST

### Patent Literature

[PTL 1] Japanese Patent Application Publication No. 2-82212

### Non Patent Literature

[NPL 1] M. Ctepanovsky, “A Comparative Review of MEMS-Based Optical Cross-Connects for All-Optical Networks From the Past to the Present Day,” IEEE Communications Surveys & Tutorials, vol. 21, no. 3, pp. 2928-2946,2019.

[NPL 2] Kenji Hiruma, Toshiki Sugawara, Kenichi Tanaka, Etsuko Nomoto, and Yong Lee, “Proposal of High—capacity and High—reliability Optical Switch Equipment with Multi—core Fibers,” 2013 18th OptoElectronics and Communications Conference held jointly with 2013 International Conference on Photonics in Switching(OECC/PS),ThT1-2,2013.

### SUMMARY OF INVENTION

### Technical Problem

However, the optical path switching described in NPL 1 has a problem that it is difficult to reduce the power consumption and size. In the above-mentioned system for moving the optical fiber V-groove stage or the prism in parallel, a motor is generally used as a driving source. In a mechanism for linearly moving a heavy object such as a stage, a certain level of torque or more is necessary for the motor, requiring power consumption for obtaining a corresponding output to maintain the necessary torque.

Furthermore, the optical axis alignment using a single-mode optical fiber requires an accuracy of approximately 1 μm or less. A ball screw is typically used as a mechanism for converting the rotational motion of the motor into linear motion. Considering that the optical fiber pitch of a normally used optical fiber array on the output side is approximately 125 μm of the cladding outer diameter of the optical fiber or approximately 250 μm of the coating outer diameter of the optical fiber, in order to convert into linear motion in sub-μm steps, it is inevitable to increase the actual driving time of the motor as the optical fiber array on the output side increases, which increases the power consumption.

Therefore, such an optical fiber type mechanical optical switch generally requires electric power of several hundred mW or more. In addition, the robot arm system using an optical connector requires a large electric power of several tens W or more for the robot arm itself for controlling the insertion and extraction of the optical connector or the ferrule.

In the optical path switching described in NPL 2 in which a multi-core optical fiber is used, a collimating mechanism for coupling to an optical fiber array on the output side and a vibration eliminating mechanism for obtaining stable optical characteristics against external factors such as vibration are separately required in the process of manufacturing the optical switch, resulting in a complicated structure.

In the optical path switching described in PTL 1 in which a ferrule into which a multi-core optical fiber is inserted is used, the ferrule is tightly inserted into a sleeve to align the central axis, and large energy is required for driving the rotation by the frictional force between the ferrule and the sleeve. Therefore, there is a problem that a large amount of electric power is required for path switching.

An object of the present disclosure is to provide a simple, compact optical switch with low power consumption.

### Solution to Problem

In the optical switch of the present disclosure, a ferrule into which a multi-core optical fiber having a plurality of cores is inserted is closely inserted into a sleeve to align the central axis, and when the optical switch is switched, the ferrule is rotated in a state where a space of a slit of the sleeve is expanded.

Specifically, an optical switch of the present disclosure includes:
a first multi-core optical fiber having a plurality of cores on the same circumference from a central axis in a cross section perpendicular to a long axis direction;
a first ferrule incorporating the first multi-core optical fiber;
a second multi-core optical fiber in which cores are arranged at respective positions corresponding to the plurality of cores of the first multi-core optical fiber in a cross section perpendicular to the long axis direction;
a second ferrule incorporating the second multi-core optical fiber and having an outer diameter equal to that of the first ferrule;
a split sleeve for accommodating the first ferrule and the second ferrule in such a manner that the first ferrule and the second ferrule are opposed to each other on a central axis;
a slit space adjustment jig for adjusting a space of a slit of the split sleeve; and
a rotation mechanism for rotating one of the first ferrule and the second ferrule around the central axis.

In the optical switch of the present disclosure, since the ferrule is rotated in a state where the space of the slit of the sleeve is widened when the optical switch is switched, the torque for rotating the ferrule may be small, and an optical switch that has low power consumption and is simple and small can be provided while maintaining the excellent points of an optical fiber type mechanical optical switch such as low loss, low wavelength dependence, multi-port property and self-retention function when the power source is lost.

The slit space adjustment jig of the optical switch according to the present disclosure may include:
a spring that is inserted into the slit to push and expand the space of the slit and a spring diaphragm for adjusting a force of the spring pushing and expanding the space;
a plurality of thin plates that are inserted into the slit to push and expand the space of the slit according to the number of the thin plates inserted, and a thin plate adjustment tool for adjusting the number of the thin plates inserted into the slit; and
a slit space adjustment member that is inserted into the slit and expand the space of the slit according to the insertion amount, and a slit space adjustment diaphragm for adjusting the insertion amount of the slit space adjustment member into the slit.

Since the optical switch of the present disclosure is configured to be able to easily expand the space of the slit of the sleeve, it is possible to provide a simple and compact optical switch with low power consumption.

In the optical switch of the present disclosure, the sum of the lengths of the first ferrule and the second ferrule may be shorter than the entire length of the split sleeve.

The rotation mechanism of the optical switch according to the present disclosure may include an actuator that rotates one of the first ferrule and the second ferrule at a constant angular step and stops at an arbitrary angular step.

The optical switch of the present disclosure may further include a first input/output unit on a side of the first multi-core optical fiber opposite to the second multi-core optical fiber, the first input/output unit coupling the plurality of cores of the first multi-core optical fiber to respective cores of a plurality of single-core optical fibers. The optical switch of the present disclosure may further include a second input/output unit on a side of the second multi-core optical fiber opposite to the first multi-core optical fiber, the second input/output unit coupling the plurality of cores of the second multi-core optical fiber to respective cores of a plurality of single-core optical fibers.

### Advantageous Effects of Invention

According to the present disclosure, a simple, compact optical switch with low power consumption can be realized.

### BRIEF DESCRIPTION OF DRAWINGS

FIG. 1 is a diagram showing a functional model of an optical switch of the present disclosure.

FIG. 2 is a block configuration diagram of the optical switch of the present disclosure.

FIG. 3-1 is a schematic diagram illustrating a structure of a multi-core optical fiber of the present disclosure.

FIG. 3-2 is a schematic diagram illustrating a structure of the multi-core optical fiber of the present disclosure.

FIG. 4 is a schematic diagram showing a cross section of an optical coupling unit according to an embodiment of the present disclosure.

FIG. 5 is a diagram showing an example of the relationship between a ferrule pull-out force Fr of a sleeve prior to expanding a slit space and a force Fw for expanding the slit space.

FIG. 6 is a schematic diagram showing a cross section of the optical coupling unit of the present disclosure.

FIG. 7 is a diagram showing an example of the relationship of excess loss to a gap between optical fibers.

FIG. 8 is a diagram showing an example of the relationship of a maximum static angle accuracy to a core arrangement radius.

FIG. 9 is a schematic diagram illustrating an example of a slit space adjustment jig of an optical coupling unit of the present disclosure.

FIG. 10 is a schematic diagram illustrating an example of a slit space adjustment jig of an optical coupling unit of the present disclosure.

FIG. 11 is a schematic diagram illustrating an example of a slit space adjustment jig of an optical coupling unit of the present disclosure.

FIG. 12 is a schematic diagram illustrating an example of a slit space adjustment jig of an optical coupling unit of the present disclosure.

FIG. 13 is a schematic diagram illustrating an example of a slit space adjustment jig of an optical coupling unit of the present disclosure.

### DESCRIPTION OF EMBODIMENTS

Embodiments of the present disclosure will be described in detail below with reference to the drawings. It is to be understood that the present disclosure is not limited to the embodiments described below. The embodiments are merely exemplary and the present disclosure can be implemented in various modified and improved modes based on the knowledge of those skilled in the art. Constituent elements with the same reference signs in the present specification and in the drawings represent the same constituent elements.

### Embodiment 1

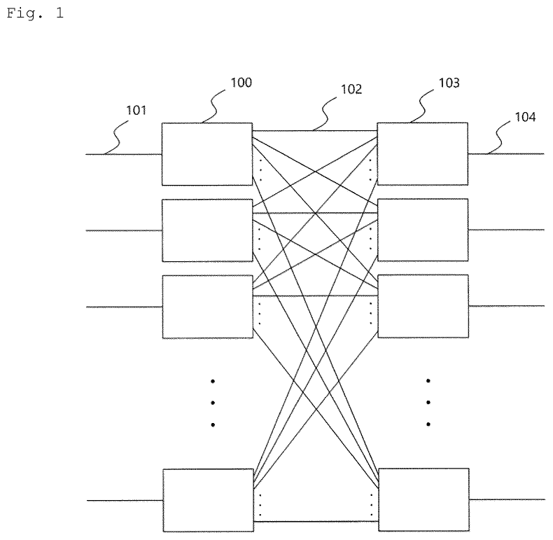

FIG. 1 shows an example of a functional model of an optical switch. In FIG. 1, reference numeral 100 denotes a front stage optical switch component, 101 an input-side optical fiber, 102 an inter-optical switch optical fiber, 103 a rear stage optical switch component, and 104 an output-side optical fiber.

The optical switch shown in FIG. 1 has a function of connecting any of N input-side optical fibers 101 to any of N output-side optical fibers 104. That is, the input-side optical fiber 101 connected to the front stage optical switch component 100 is switched to an arbitrary port of the inter-optical switch optical fiber 102 by the front stage optical switch component 100, and the port of the inter-optical switch optical fiber 102 is switched to a desired output-side optical fiber 104 by the rear stage optical switch component 103.

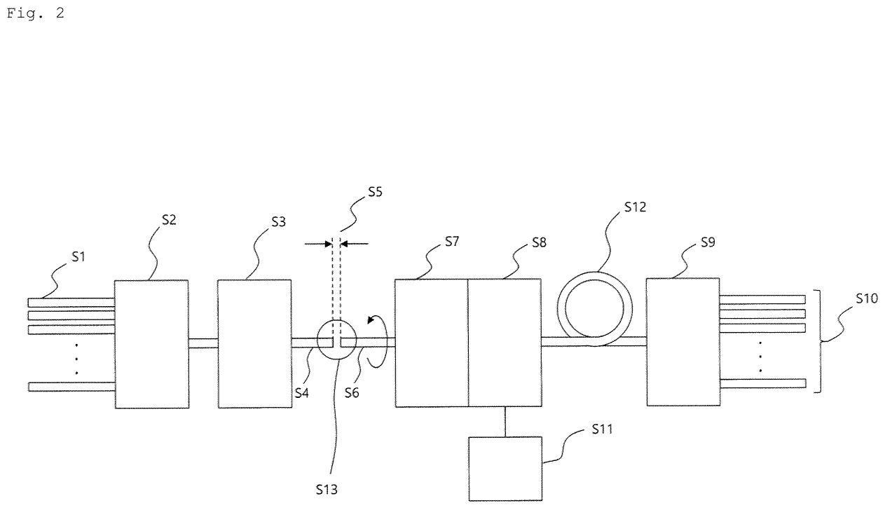

FIG. 2 shows a block configuration diagram of the optical switch of the present embodiment. In FIG. 2, S1 is an input-side single-core optical fiber, S2 a fan-in as a first input/output unit, S3 a rotation stop mechanism, S4 an input-side multi-core optical fiber as a first multi-core optical fiber, S5 a gap, S6 an output-side multi-core optical fiber as a second multi-core optical fiber, S7 a rotating portion as a part of a rotation mechanism, S8 an actuator as a part of the rotation mechanism, S9 a fan-out as a second input/output unit, S10 an output-side single-core optical fiber, S11 a control circuit, S12 an extra long portion, and S13 an optical coupling unit.

The optical switch shown in FIG. 2 includes the input-side multi-core optical fiber S4, the output-side multi-core optical fiber S6, the fan-in S2, and the fan-out S9, wherein light is made incident from a plurality of the input-side single-core optical fibers S1 through the fan-in S2, and the light can be output from any one of the single-core optical fibers S10 of the fan-out S9 by fixing the input-side multi-core optical fiber S4 and rotating the output-side multi-core optical fiber S6 at the optical coupling unit S13.

The optical switch shown in FIG. 2 can be used as a 1×N relay type optical switch if the input is singular. If a plurality of inputs are provided, it is also possible to configure N×N optical switches by combining a plurality of optical switches having different directions of optical paths. Here, although the input-side multi-core optical fiber S4 is fixed and the output-side multi-core optical fiber S6 is rotated, a configuration is sufficient in which switching of fibers is enabled by fixing either of the input and the output and rotating the opposite side; that is, the output-side multi-core optical fiber S6 may be fixed and the input-side multi-core optical fiber S4 may be rotated. An optical switch where the input-side multi-core optical fiber S4 is fixed and the output-side multi-core optical fiber S6 is rotated will be described below.

The input-side multi-core optical fiber S4 is fixed by the rotation stop mechanism S3 so as not to be axially rotated. The actuator S8 which rotates at an arbitrary angle by a signal from the control circuit S11 rotates the rotating portion S7 about its central axis, and the output-side multi-core optical fiber S6 rotates axially with the rotation of the rotating portion S7. The extra long portion S12 having a constant optical fiber length is provided in order to allow for twisting of the output-side multi-core optical fiber S6. The gap S5 is provided in the optical coupling unit S13, so that even when the output-side multi-core optical fiber S6 is rotated, the output-side multi-core optical fiber S6 does not interfere with the input-side multi-core optical fiber S4.

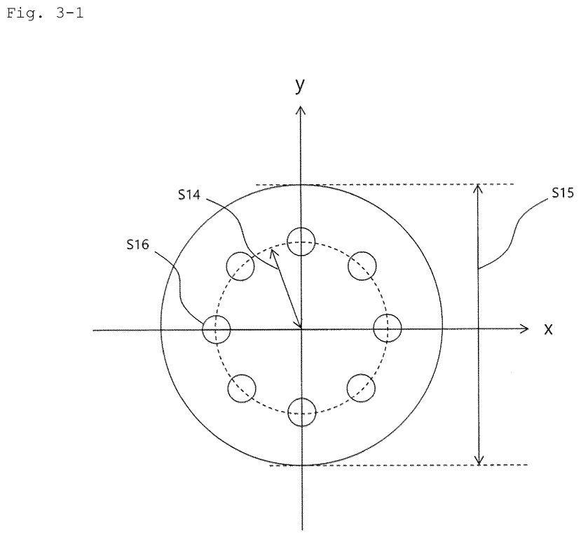

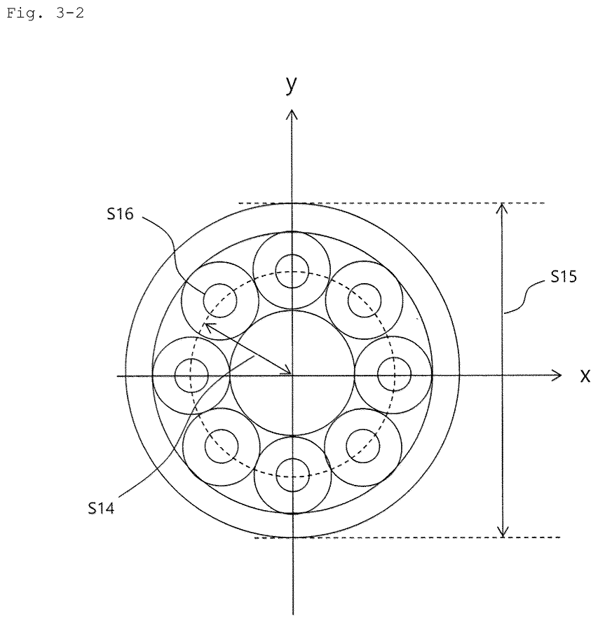

FIGS. 3-1 and 3-2 are each a schematic diagram illustrating a cross-sectional structure of a multi-core optical fiber of the present disclosure that is perpendicular to a long axis direction. In FIGS. 3-1 and 3-2, S14 is a core arrangement radius, S15 an optical fiber cladding diameter, and S16 a core. In FIG. 3-1, eight cores are provided in a common cladding. In FIG. 3-2, eight single-core optical fibers are bundled, melted, and stretched into a bundle. In the present application, a multi-core optical fiber having a plurality of cores shown in FIG. 3-1 and a bundled optical fiber obtained by melting and stretching a plurality of single-core optical fibers shown in FIG. 3-2 are collectively referred to as a multi-core optical fiber.

As shown in FIGS. 3-1 and 3-2, the centers of the plurality of cores S16 are arranged on the circumference of a circle having the core arrangement radius S14, with respect to the center of the optical fiber. The number of cores S16 where both cores are arranged at corresponding positions is not limited to 8. Although the number of cores of the input-side multi-core optical fiber S4 and the number of cores of the output-side multi-core optical fiber S6 are the same, the number of cores of the input-side multi-core optical fiber S4 and the number of cores of the output-side multi-core optical fiber S6 do not have to be the same; for example, the number of cores of the input-side multi-core optical fiber S4 may be four and the number of cores of the output-side multi-core optical fiber S6 may be eight under the condition of the same core arrangement radius.

It is important that the transmission loss of the optical coupling unit S13 be as small as possible, and it is desirable that the input-side multi-core optical fiber S4 and the output-side multi-core optical fiber S6 have the same optical characteristics from the perspective that these two multi-core optical fibers have the same mode field diameter. The optical fiber cladding diameter S15 may be 125 μm which is widely used for communication or a cladding diameter of, for example, 190 μm, which is enlarged to realize a large number of cores.

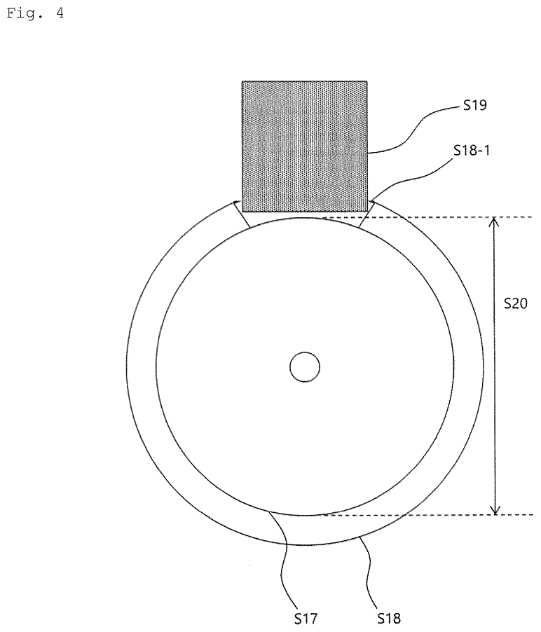

FIG. 4 is a schematic diagram showing a cross section of the optical coupling unit according to an embodiment of the present disclosure. In FIG. 4, S17 is a ferrule, S18 a split sleeve, S18-1 a slit of the split sleeve S18, S19 a slit space adjustment jig, and S20 a ferrule outer diameter. The ferrule S17 corresponds to the first ferrule or the second ferrule. The ferrule S17 into which the multi-core optical fiber is inserted is housed in the cylindrical split sleeve S18. The ferrule S17 is aligned by the split sleeve S18 having an axial slit. The inner diameter of the split sleeve S18 is designed to be smaller than the ferrule outer diameter S20 by approximately sub pm. When the ferrule S17 is inserted into the split sleeve S18, the width of the slit S18-1 of the split sleeve S18 is widened, and the inner diameter of the split sleeve S18 becomes equal to the ferrule outer diameter S20, thereby controlling the axial deviation of the cores of the multi-core optical fiber.

A force that grips the ferrule toward the ferrule center occurs in the split sleeve S18, and the ferrule S17 is held by this gripping force. The slit space adjustment jig S19 for reducing the gripping force by further expanding the space of the slit S18-1 of the split sleeve S18 is attached to the slit S18-1.

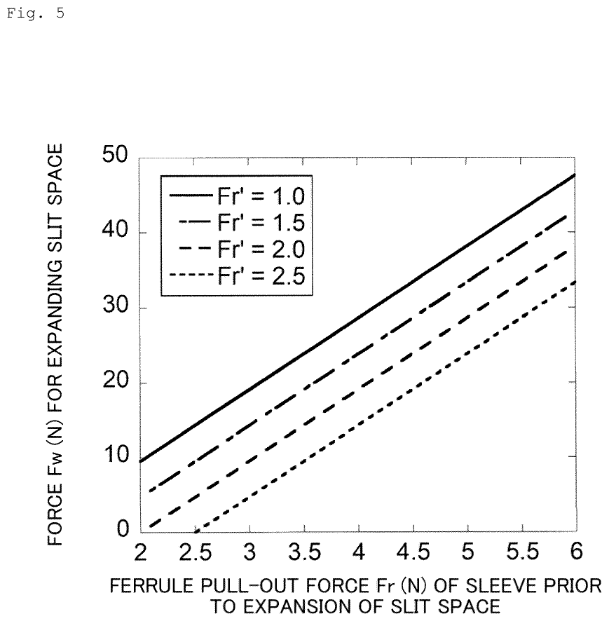

The slit space adjustment jig S19 is capable of micrometer-order fine slit spacing adjustment by, for example, combining a spring and a micrometer head. The slit space adjustment jig S19 is not limited to the combination of a spring and a micrometer head, but may be configured to be able to finely adjust the slit space. FIG. 5 shows an example of the relationship between a ferrule pull-out force Fr of the sleeve prior to expanding the slit space and a force Fw for expanding the slit space. The ferrule pull-out force Fr of the sleeve can be expressed by the equation (1) by using a friction coefficient μ between the ferrule and the sleeve and the gripping force F applied in the direction of the center of the ring of the sleeve.

[Math. 1]

Fᵣ=4μF (1)

When the force Fw is applied in the direction in which the slit space is widened, the gripping force F is reduced by the action of force decomposition. The ferrule pull-out force Fr of the sleeve after the slit space is widened can be expressed by the equation (2) by using an opening angle α of the slit.

$$[ Math . 2 ]$$

$${F}_{r}^{′} = 4 μ \sqrt{[ {F}^{2} + {F}_{w}^{2} - 2 {FF}_{w} cos ( \frac{π}{2} - \frac{α}{2} ) ] - {[ {F}_{w} cos ( \frac{α}{2} ) ]}^{2}} \qquad ( 2 )$$

FIG. 5 shows an example in which a zirconia sleeve and a zirconia ferrule are used, and the friction coefficient μ is 0.1. The ferrule pull-out force of the sleeve is correlated with a connection loss fluctuation, and the loss fluctuation can be suppressed to 0.1 dB or less when the ferrule pull-out force of the sleeve is 1.5 N or more. For example, when the ferrule pull-out force Fr of the sleeve before expanding the slit space is 3 N (gripping force F of 7.5 N), the ferrule pull-out force Fr of the sleeve after expanding the slit space can be suppressed to 2 N (gripping force of 5 N) by adding 10 N to the force Fw for expanding the sleeve space.

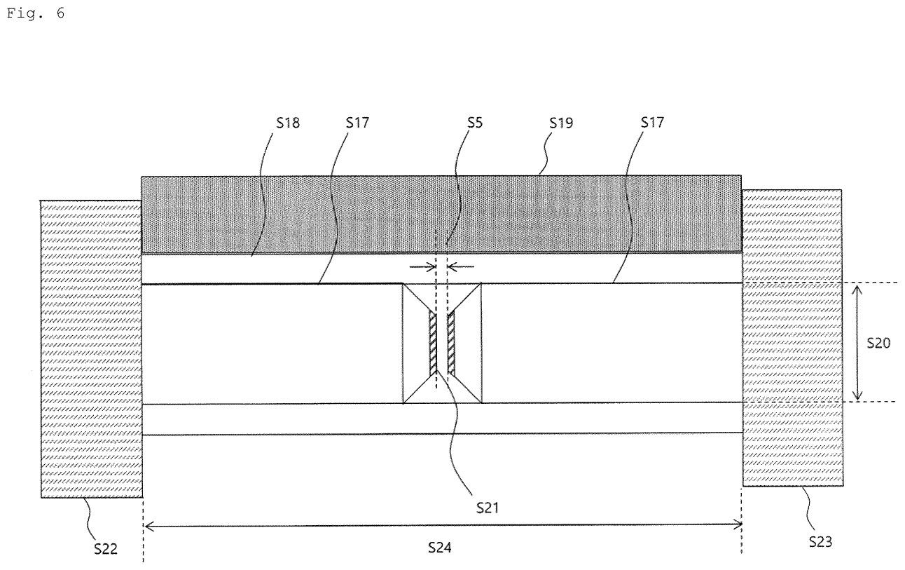

FIG. 6 is a schematic diagram showing a cross section of the optical coupling unit S13 of the present disclosure. In FIG. 6, S17 is a ferrule, S18 a split sleeve, S19 a slit space adjustment jig, S20 a ferrule outer diameter, S21 an antireflection film, S22 an input-side flange, S23 an output-side flange, and S24 a sleeve axial length.

The input-side multi-core optical fiber S4 and the output-side multi-core optical fiber S6 are incorporated in respective ferrules S17. The two ferrules 17 are opposed to each other at the central axis by the split sleeve S18. End faces of the two ferrules S17 may be in contact with each other or separated. The end faces of the ferrules S17 are polished, and coated with the antireflection film S21 for reducing Fresnel reflection with an air layer. As another method for reducing Fresnel reflection, oblique polishing in which the ferrule end faces are not flat and polished at a constant angle can be performed instead. In this case, the gap S5, a polishing angle, and a ferrule tip shape are required so that the ferrule end faces do not come into contact with the input-side ferrule when the output-side ferrule is rotated.

The sum of the lengths of the first ferrule S17 and the second ferrule S17 is shorter than the total length of the split sleeve S18. Therefore, a gap is created between the end faces of the first ferrule S17 and the second ferrule S17 in the optical coupling unit S13. As a result, even if the second ferrule S17 rotates, damage to the antireflection film S21 can be prevented. In a case where the antireflection film S21 is not provided on a fiber end face, damage to the fiber end face can be prevented.

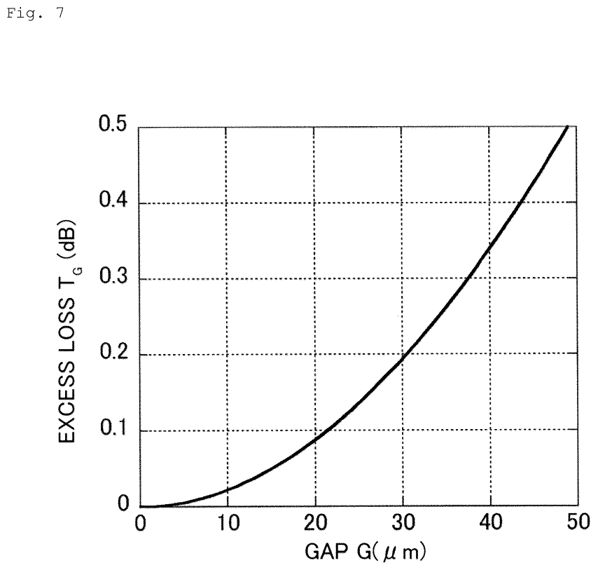

FIG. 7 shows an example of the relationship of an excess loss T_{G} with respect to a gap G of the optical fiber. In optical coupling between optical fibers, if there is a gap between the fiber end faces, the distribution of the outgoing light from the input-side optical fiber is broadened, and the efficiency of coupling with the core of the output-side optical fiber is reduced, causing excess loss. The relationship between the gap G (unit: μm) and the excess loss T_{G} (unit: dB) can be expressed by the equation (3).

$$[ Math . 3 ]$$

$${T}_{G} = \frac{4 [ 4 {G}^{2} + \frac{{w}_{1}^{2}}{{w}_{2}^{2}} ]}{{[ 4 {G}^{2} + \frac{{w}_{2}^{2} + {w}_{1}^{2}}{{w}_{2}^{2}} ]}^{2} + 4 {G}^{2} \frac{{w}_{2}^{2}}{{w}_{1}^{2}}} \qquad ( 3 )$$

Here, W₁ and W₂ are the core of the input-side multi-core optical fiber and the mode field radius of the output-side multi-core optical fiber, respectively. FIG. 7 is a diagram showing the loss that occurs when the mode field radii of both the input-side multi-core optical fiber and the output-side multi-core optical fiber are 4.5 μm. For example, by arranging the respective ferrules S17 so that the gap between the end faces of the input-side multi-core optical fiber S4 and the output-side multi-core optical fiber S6 is 20 μm or less, the excess loss can be suppressed to 0.1 dB or less.

The minimum value of the gap S5 in the optical coupling unit S13 is secured by the axial length S24 of the sleeve S18, the input-side flange S22, and the output-side flange S23. Specifically, the length of the sleeve S18 is set to be longer than the total length of projection from the input-side flange S22 and the output-side flange S23 for fixing the input-side ferrule S17 and the output-side ferrule S17, respectively, and thereby the gap S5 can be secured.

The actuator S8 will now be described. The actuator S8 is a drive mechanism which rotates at a constant angular step by a pulse signal from the control circuit S11 and has a constant static torque at every angular step so as to stop at an arbitrary angular step. For example, a stepping motor can be applied to the actuator S8. The actuator S8 is not limited to a stepping motor, as long as it is a drive mechanism that rotates at a constant angular step by a pulse signal from the control circuit S11 and has a constant static torque at each angular step.

The rotational speed and the rotational angle are determined by the period and the number of pulses of the pulse signal from the control circuit S11, and the angular step and the static torque may be adjusted through a reduction gear. Although the output-side ferrule S17 in the optical coupling unit S13 has a self-retention function to be held by the split sleeve S18 as described above, the output-side ferrule S17 may also be provided by, for example, the static torque of an actuator portion.

In the stepping motor, when the number of angular steps in which the angle position is held when the power supply is stopped is defined as the number of static angular steps, the number of static angular steps is a natural number multiple of the number of cores having the same core arrangement radius of the output-side multi-core optical fiber.

When the excess loss due to a rotation angle deviation in the optical coupling unit S13 is T_{R} (unit: dB), and static angle accuracy of the stepping motor is θ (unit: degrees), and the core arrangement radii of the input-side multi-core optical fiber S4 and the output-side multi-core optical fiber S6 are R (unit: μm), these relations can be expressed by the equation (4) by using the mode field radius w₁ of the input-side and multi-core optical fiber and the mode field radius w₂ of the output-side multi-core optical fiber.

$$[ Math . 4 ]$$

$${T}_{R} = {( \frac{2 {w}_{1} {w}_{2}}{{w}_{1}^{2} + {w}_{2}^{2}} )}^{2} exp [ 1 \frac{2 {( 2 R sin 2 π \frac{θ}{360} )}^{2}}{{w}_{1}^{2} + {w}_{2}^{2}} ] \qquad ( 4 )$$

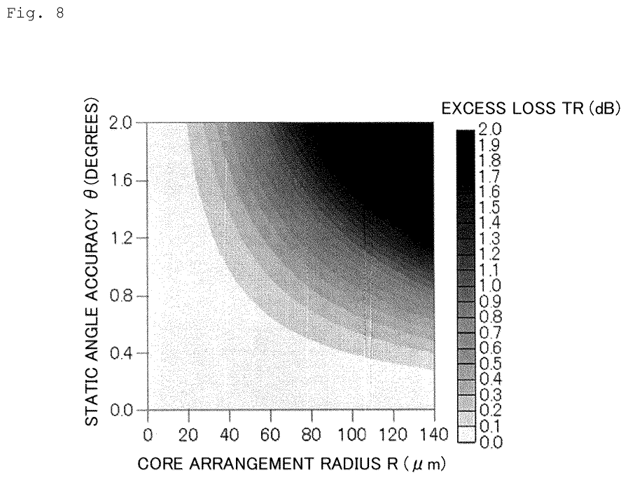

When the excess loss T_{R} is set to 0.1 dB or 0.2 dB, for example, the maximum static angle accuracy θ is given with respect to the core arrangement radius R as shown in FIG. 8. As shown in FIG. 8, the larger the core arrangement radius is, the tighter the static angle accuracy required, and when the excess loss T_{R} is 0.1 dB, the static angle accuracy of approximately 0.8 degrees or less with a core arrangement radius of 50 μm is required.

The optical switch of the present disclosure has a mechanism that allows axial rotation of one of the input side and the output side of the optical coupling unit that performs optical switching, realizes the self-retention function by ferrule gripping force of the split sleeve, and minimizes the gripping force. Therefore, the energy required in the actuator, which is a torque output, can be reduced. Furthermore, the optical switch includes a self-retention function that does not require electric power when stationary after switching. For this reason, power consumption can be reduced. In addition, the optical coupling portion does not need to be provided with a collimating mechanism or a special vibration-proof mechanism. Therefore, an optical switch having a simple, small configuration can be realized. Further, the amount of optical axis deviation in the direction other than the axial rotation of the output-side ferrule is guaranteed by the sleeve at the optical coupling portion. Accordingly, loss can be reduced.

### Embodiment 2

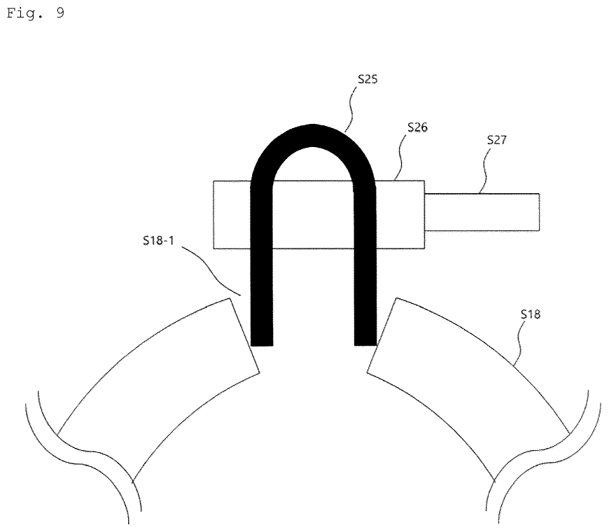

FIG. 9 is a schematic diagram showing an example of the slit space adjustment jig disposed in the optical coupling portion of the present disclosure. In FIG. 9, S18 is a split sleeve, S18-1 a slit, S25 a spring, S26 a fixture, and S27 a spring diaphragm. The spring S25 pushes and expands the space of the slit S18-1 of the split sleeve S18. The spring diaphragm S27 adjusts the force of the spring S25 pushing and expanding.

The operation of the slit space adjustment jig will be described with reference to FIG. 9. The spring S25 and the spring diaphragm S27 are attached to the fixture S26. When the spring S25 is not throttled by the spring diaphragm S27, the space of the tip of the spring S25 is wider than the space of the slit S18-1 of the split sleeve S18. The spring S25 is throttled by the spring drawing S27 in advance, and then the tip of the spring S25 is inserted into the slit S18-1 of the split sleeve S18. By opening the spring diaphragm S27 in a direction in which the tip of the spring S25 expands, the space of the slit S18-1 of the split sleeve S18 can be expanded. For example, a leaf spring or a kick spring can be used as the spring S25, and the tip of the spring S25 may have a shape to which the pressure of the spring is applied in a direction in which the space of the slit S18-1 of the split sleeve S18 expands, but the configuration of the spring S25 is not limited thereto.

The spring diaphragm S27 may be, for example, a micrometer head or a caliper, and may have a configuration in which the spring S25 can be throttled and released with a fine scale, but the configuration of the spring diaphragm S27 is not limited thereto. Further, the spring diaphragm S27 is provided with a lock mechanism, so that appropriate pressure of the spring can be maintained. When the optimum pressure of the spring S25 for expanding the space of the slit S18-1 is known in advance, for example, a switch capable of turning on/off such as a solenoid can be used as the spring diaphragm S27.

### Embodiment 3

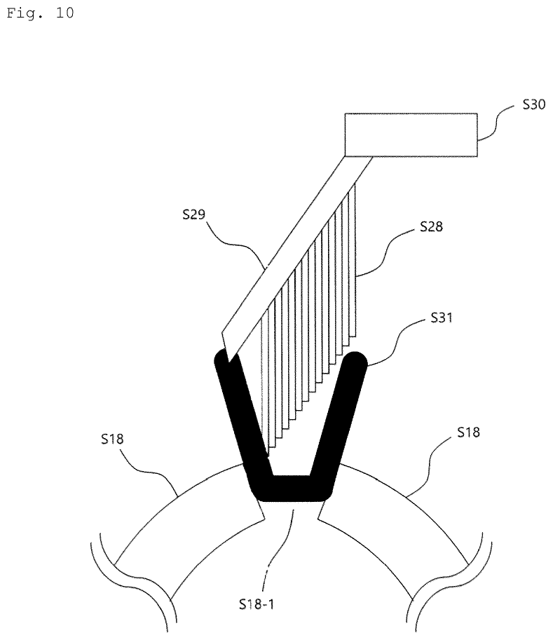

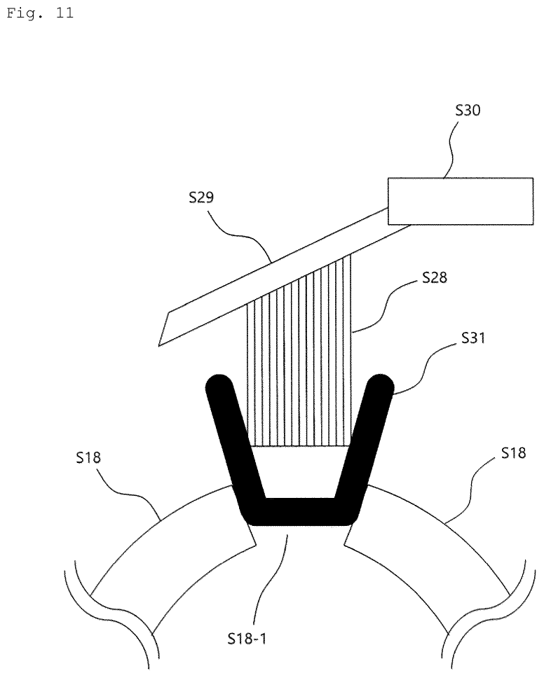

FIGS. 10 and 11 are schematic diagrams showing an example of the slit space adjustment jig disposed in the optical coupling portion of the present disclosure. FIG. 10 shows a state in which the space of the slit S18-1 of the split sleeve S18 is not widened. FIG. 11 shows a state in which the space of the slit S18-1 of the split sleeve S18 is widened. In FIGS. 10 and 11, S18 is a split sleeve, S18-1 a slit, S28 a thin plate, S29 a thin plate fixture, S30 a thin plate adjustment tool, and S31 a thin plate storage tool. The thin plate S28 pushes and expands the space of the slit S18-1 according to the number of the thin plates inserted into the slit S18-1. The thin plate adjustment tool S30 adjusts the number of the thin plates S28 inserted into the slit S18-1.

The operation of the slit space adjustment jig will be described with reference to FIG. 10. A plurality of thin plates S28 are used to adjust the space of the slit S18-1 of the split sleeve S18. The upper parts of the plurality of thin plates S28 are each fixed to the thin plate fixture S29. The thin plate adjustment tool S30 is attached to the thin plate fixture S29, to adjust the angle of the thin plate fixture S29. The thin plate S28 is stored in a thin plate storage tool S31. The thin plate storage tool S31 is fixed to the inside of the slit S18-1 of the split sleeve S18. When the angle of the thin plate fixture S29 is changed by the thin plate adjustment tool S30, the plurality of thin plates S28 are inserted into and extracted from respective slits S18-1, and the width of the thin plate storage tool S31 inside the slits S18-1 can be adjusted.

In FIG. 11, when the angle of the thin plate fixture S29 is adjusted by the thin plate adjustment tool S30 so as to push the thin plate S28 into the thin plate storage tool S31, the width of the thin plate storage tool S31 inside the slit S18-1 is widened by the thin plate S28. As a result, the space of the slit S18-1 of the split sleeve S18 expands.

A feeler gauge, for example, can be used as the thin plate S28. The number of filler gauges inserted into the slit S18-1 is changed by the angle adjustment on the thin plate fixture S29, and the width of the thin plate storage tool S31 inside the slit S18-1 can be finely adjusted; however, the configuration is not limited thereto.

FIGS. 10 and 11 show a configuration in which the plurality of thin plates S28 are used, but when the width for expanding the slit S18-1 is known in advance, it is also possible to use one thin plate having a width which makes the width inside of the slit S18-1 of the thin plate storage tool S31 optimum. The thin plate storage tool S31 may be made of, for example, a shape-memory alloy, and the width inside the slit S18-1 may be adjusted; however, the configuration is not limited thereto.

### Embodiment 4

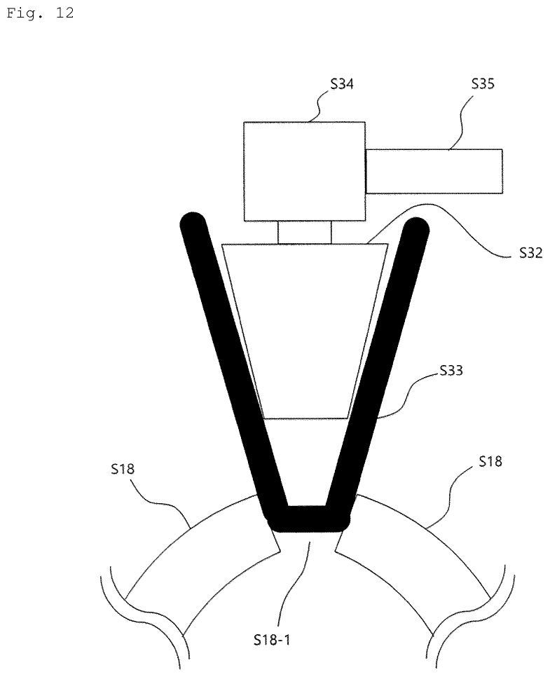

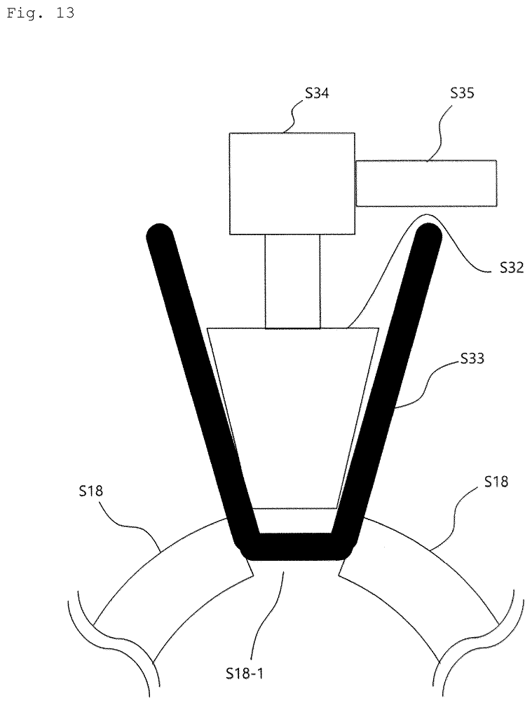

FIGS. 12 and 13 are schematic diagrams showing an example of the slit space adjustment jig disposed in the optical coupling portion of the present disclosure. FIG. 12 shows a state in which the space of the slit S18-1 of the split sleeve S18 is not widened. FIG. 13 shows a state in which the space of the slit S18-1 of the split sleeve S18 is widened. In FIGS. 12 and 13, S18 is a split sleeve, S18-1 a slit, S32 a slit space adjustment member, S33 a slit space adjustment member storage tool, S34 a slit space adjustment member fixture, and S35 a slit space adjustment diaphragm. The slit space adjustment member S32 is inserted into the slit S18-1, and expands the space of the slit S18-1 according to the insertion amount. The slit space adjustment diaphragm S35 adjusts the insertion amount of the slit space adjustment member S32 into the slit S18-1.

The operation of the slit space adjustment jig will be described with reference to FIGS. 12 and 13. The slit space of the split sleeve S18 is adjusted by the slit space adjustment member S32 having a truncated cone shape. The upper part of the slit space adjustment member S32 is fixed to the slit space adjustment member fixture S34. The slit space adjustment diaphragm S35 is attached to the slit space adjustment member fixture S34, and adjusts the amount of insertion and extraction of the slit space adjustment member S32. The slit space adjustment member S32 is stored in the slit space adjustment member storage tool S33. The slit space adjustment member storage tool S33 is fixed to the inside of the slit S18-1 of the split sleeve S18. The slit space adjustment member S32 is inserted and extracted by the slit space adjustment diaphragm S35, and the width of the slit space adjustment member storage tool S33 inside the slit S18-1 is adjusted.

In FIG. 13, the slit space adjustment member S32 is inserted into the slit space adjustment member storage tool S33 by the slit space adjustment diaphragm S35, and the width of the slit space adjustment member storage tool S33 inside the slit S18-1 is widened. As a result, the space of the slit S18-1 of the split sleeve S18 expands.

The slit space adjustment member S32 may have a shape capable of adjusting the insertion amount of the slit space adjustment member storage tool S33 into the slit S18-1 by adjusting the slit space adjustment diaphragm S35; however, the shape of the slit space adjustment member S32 is not limited to a truncated cone and may be a conical shape or a wedge shape. Metal and resin are examples of the material of the slit space adjustment member S32.

FIGS. 12 and 13 show a configuration in which the slit space adjustment member S32 having a truncated cone shape is used, but when the width for expanding the slit S18-1 is known in advance, a columnar slit space adjustment member having a width to optimize the width inside the slit S18-1 of the slit space adjustment member storage tool S33 may be used. The slit space adjustment member storage tool S33 is only required to be able to adjust the width inside the slit S18-1, and for example, a shape-memory alloy can be used.

As described above, the optical switch of the present disclosure enables low power consumption, simplicity, and miniaturization while maintaining the features of an optical fiber type mechanical optical switch, such as low loss, low wavelength dependence, multi-port capability, and self-retention function in case of power loss.

### INDUSTRIAL APPLICABILITY

The present disclosure can be applied to the information and communication industries.

### REFERENCE SIGNS LIST

100: Front stage optical switch component
101: Input-side optical fiber
102: Inter-optical switch optical fiber
103: Rear stage optical switch component
104: Output-side optical fiber
S1: Input-side single-core optical fiber
S2: Fan-in
S3: Rotation stop mechanism
S4: Input-side multi-core optical fiber
S5: Gap
S6: Output-side multi-core optical fiber
S7: Rotating portion
S8: Actuator
S9: Fan-out
S10: Output-side single-core optical fiber
S11: Control circuit
S12: Extra long portion
S13: Optical coupling unit
S14: Core arrangement radius
S15: Optical fiber cladding diameter
S16: Core
S17: Ferrule
S18: Split sleeve
S18-1: Slit
S19: Slit space adjustment jig
S20: Ferrule outer diameter
S21: Antireflection film
S22: Input-side flange
S23: Output-side flange
S24: Length in sleeve axial direction
S25: Spring
S26: Fixture
S27: Spring diaphragm
S28: Thin plate
S29: Thin plate fixture
S30: Angle adjustment tool
S31: Thin plate storage tool
S32: Slit space adjustment member
S33: Slit space adjustment member storage tool
S34: Slit space adjustment member fixture
S35: Slit space adjustment diaphragm

1. An optical switch, comprising:
a first multi-core optical fiber having a plurality of cores on the same circumference from a central axis in a cross section perpendicular to a long axis direction;
a first ferrule incorporating the first multi-core optical fiber;
a second multi-core optical fiber in which cores are arranged at respective positions corresponding to the plurality of cores of the first multi-core optical fiber in a cross section perpendicular to the long axis direction;
a second ferrule incorporating the second multi-core optical fiber and having an outer diameter equal to that of the first ferrule;
a split sleeve for accommodating the first ferrule and the second ferrule in such a manner that the first ferrule and the second ferrule are opposed to each other on a central axis;
a slit space adjustment jig for adjusting a space of a slit of the split sleeve; and
a rotation mechanism for rotating one of the first ferrule and the second ferrule around the central axis.

2. The optical switch according to claim 1, wherein the slit space adjustment jig includes a spring inserted into the slit to expand the space of the slit and a spring diaphragm for adjusting a force of the spring pushing and expanding the space of the slit.

3. The optical switch according to claim 1, wherein the slit space adjustment jig includes a plurality of thin plates inserted into the slit to push and expand the space of the slit according to the number of the thin plates inserted, and a thin plate adjustment tool for adjusting the number of the thin plates inserted into the slit.

4. The optical switch according to claim 1, wherein the slit space adjustment jig includes a slit space adjustment member inserted into the slit to push and expand the space of the slit according to an insertion amount, and a slit space adjustment diaphragm for adjusting the insertion amount of the slit space adjustment member into the slit.

5. The optical switch according to claim 1, wherein a sum of lengths of the first ferrule and the second ferrule is shorter than an entire length of the split sleeve.

6. The optical switch according to claim 1, wherein the rotation mechanism includes an actuator that rotates one of the first ferrule and the second ferrule at a constant angular step and stops at an arbitrary angular step.

7. The optical switch according to claim 1, further comprising a first input/output unit on a side of the first multi-core optical fiber opposite to the second multi-core optical fiber, the first input/output unit coupling the plurality of cores of the first multi-core optical fiber to respective cores of a plurality of single-core optical fibers.

8. The optical switch according to claim 1, further comprising a second input/output unit on a side of the second multi-core optical fiber opposite to the first multi-core optical fiber, the second input/output unit coupling the plurality of cores of the second multi-core optical fiber to respective cores of a plurality of single-core optical fibers.
